(19) United States
(12) Patent Application Publication
(10) Pub. No.: US 2009/0222430 A1
(43) Pub. Date: Sep. 3, 2009

(54) Apparatus and Method for Content Recommendation

(75) Inventors: Paola M. Hobson, Alton (GB); Sergey N. Baranov, St. Petersburg (RU)

Correspondence Address: MOTOROLA INC, 600 NORTH US HIGHWAY 45, W4 - 39Q, LIBERTYVILLE, IL, 60048-5343, US

(73) Assignee: Motorola, Inc., Libertyville, IL (US)

(21) Appl. No.: 12/039,376

(22) Filed: Feb. 28, 2008

(51) Int. Cl. G06F 7/00

(52) U.S. Cl. 707/5

(57) ABSTRACT

A content recommender executes a method wherein a set of attributes are provided for a plurality of content items. A number of recommendation parameters are defined as a function of attribute values for a subset of attributes and for each content item, recommendation values are determined based on the definitions. A multi-dimensional clustering is applied to the recommendation values for the content items to generate a plurality of content clusters. Each dimension of the clustering corresponds to a recommendation parameter. The content recommender then selects a set of content clusters from the content clusters and a recommendation set of content items is generated by selecting at least one content item from each selected content cluster. The invention may allow improved recommendations to be generated and may in particular allow recommendations to be generated which reflect a number of different and possibly conflicting considerations.

### FIELD OF THE INVENTION

The invention relates to an apparatus and method for content recommendation and in particular, but not exclusively, to content recommendation for multimedia content items.

### BACKGROUND OF THE INVENTION

In recent years, the availability and provision of multimedia and entertainment content has increased substantially. For example, the number of available television and radio channels has grown considerably and the popularity of broadband wireless, broadband cellular, satellite media, cable transmission, on-demand services and the Internet has provided new content distribution means. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content, personalizing services etc.

As an example, television recommender systems are becoming a popular way to help people navigate a large and increasing number of program options in order to find the programs that fit their individual (or family group) preferences. For example, Digital Video Recorders (DVRs) or Personal Video Recorders (PVRs) which comprise functionality for providing recommendations of television programs to the user based on user preferences are becoming increasingly popular. More specifically, such devices can comprise functionality for monitoring the viewing/recording preferences of a user. These preferences can be stored in a user profile which subsequently can be used to autonomously select and recommend suitable television programs for viewing or recording. E.g. a DVR may automatically record programs which are then recommended to the user, for example by inclusion of the automatically recorded programs in a listing of all the programs recorded by the DVR.

In order to enhance the user experience, it is advantageous to personalise the recommendations to the individual user as much as possible. The process of generating recommendations requires that a user profile has been captured so that known user preferences can be used as input data by the prediction algorithm.

However, although known recommendation systems may provide an improved user experience they tend to be relatively limited and typically focused on either the user needs or the content provider requirements in terms of the number of different parameters and characteristics that are taken into account when generating the recommendations. Typically recommendations may be generated by matching characteristics of content items to a user preference profile and recommending the content items resulting in the highest estimated preference to the user.

However, in many applications it is desirable to also include other parameters and considerations such as e.g. preferences of content providers etc. Thus, whereas conventional recommendation systems can identify what content is likely to be of interest to the user, operators and content providers often prefer to decide or at least influence what content is offered to users. For example, they may prefer that specific content is recommended (e.g. pilot episodes of new television series, more expensive television programmes etc). Current recommendation systems tend not to allow such preferences to be considered and reflected in the recommendations. Furthermore, generating recommendations reflecting such different and typically conflicting preferences requires the system to be able to automatically consider and balance many different parameters which is difficult to achieve while maintaining flexibility.

Hence, an improved recommendation system would be advantageous and in particular a recommendation system allowing increased flexibility, facilitated operation, consideration and/or balancing of different characteristics, parameters and/or preferences (such as from users and content providers), improved diversity and/or accuracy of recommendations and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a method of content recommendation comprising: providing a set of attributes for each content item of a plurality of content items; determining a recommendation value for a first number of recommendation parameters for each of the plurality of content items, each recommendation parameter being defined as a function of attribute values for a subset of attributes of the set of attributes; generating a plurality of content clusters by a multi-dimensional clustering of the plurality of content items in response to the recommendation values, each dimension corresponding to a recommendation parameter; selecting a first set of content clusters from the plurality of content clusters; and generating a first recommendation set of content items by selecting at least one content item from each content cluster of the first set of content clusters.

The invention may allow improved recommendations to be generated and/or may facilitate implementation. In particular, the invention may allow a number of different types of attributes reflecting different and possibly conflicting preferences and characteristics to be jointly considered when generating recommendations. The invention may for example in some embodiments allow an efficient consideration and balancing of attributes indicative of user preferences, content provider preferences, operator preferences etc.

Each recommendation parameter may specifically reflect a different set of considerations. For example, one parameter may be determined in response to user preferences, a second parameter in response to content provider preferences, a third parameter in response to properties not associated with either a user preference or a content provider preference etc. The definition may define a parameter value as a function of attribute values for the attributes in the corresponding subset of attributes. The function may be a mathematical relationship or may e.g. be a value resulting from executing an algorithm including a consideration of the attribute values. The algorithm may for example include a look-up table, conditional calculations or value assignments etc.

The recommendation value may be a numeric value or may e.g. be any information or data that can be used by a clustering algorithm.

According to another aspect of the invention there is provided content item recommendation apparatus comprising: a unit for receiving a set of attributes for each content item of a plurality of content items; a unit for determining a recommendation value for a first number of recommendation parameters for each of the plurality of content items, each recommendation parameter being defined as a function of attribute values for a subset of attributes of the set of attributes; a unit for generating a plurality of content clusters by a multi-dimensional clustering of the plurality of content items in response to the recommendation values, each dimension corresponding to a recommendation parameter; a unit for selecting a first set of content clusters from the plurality of content clusters; and a unit for generating a first recommendation set of content items by selecting at least one content item from each content cluster of the first set of content clusters.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a content item recommendation apparatus in accordance with some embodiments of the invention;

FIG. 2 illustrates an example of a flowchart of a method of content item recommendation in accordance with some embodiments of the invention; and

FIG. 3 illustrates an example of a multi-dimensional clustering of content items in accordance with some embodiments of the invention.

### DETAILED DESCRIPTION OF SOME EMBODIMENTS OF THE INVENTION

The following description focuses on embodiments of the invention applicable to a recommendation system for generating recommendations for content items such as downloadable radio programmes. However, it will be appreciated that the invention is not limited to this application but may be applied to many other applications and types of content items, such as for example video clips, audio clips, data files, executable files, text documents, songs, games, television programmes etc. The content items are specifically electronically distributed content items.

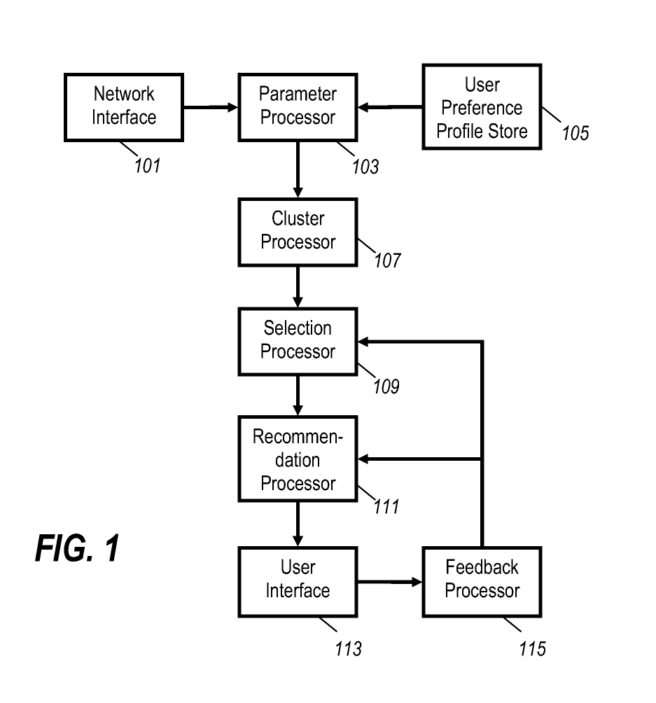

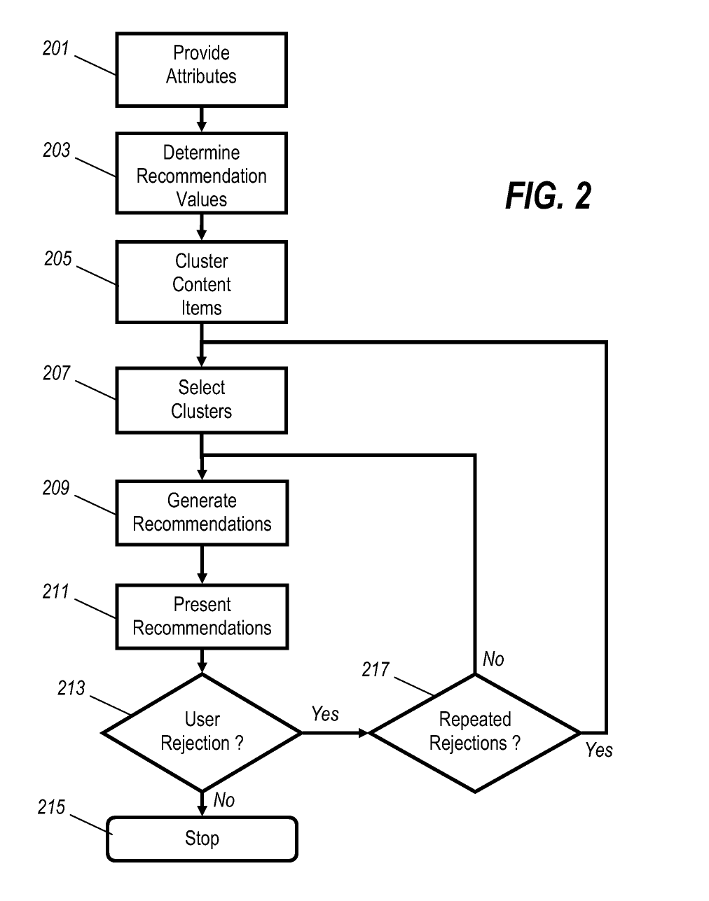

FIG. 1 illustrates an example of a content item recommendation apparatus in accordance with some embodiments of the invention and FIG. 2 illustrates an example of a flowchart of a method of content item recommendation in accordance with some embodiments of the invention. The method is specifically performed by the apparatus of FIG. 1. The apparatus may for example be a computer, an Internet radio etc.

The content recommender is arranged to generate recommendations of specific content items out of a large pool of content items available to the user. The user may then select one of the recommended content items for presentation.

The content recommender implements a content recommendation algorithm which allows different types and sources of preferences to be automatically evaluated and balanced. In particular, the content recommender may specifically generate recommendations with a large variation and which includes recommendations with very different weightings of the different preferences.

In particular, the recommendation process includes an evaluation of each content item relative to different criteria reflecting different preference considerations. The criteria may be orthogonal and e.g. one criterion may represent a user preference, another criterion may represent a content operator preference and a third criterion may represent considerations which are not directly related to the content provider or user preferences such as e.g. a popularity of the content item for a group of users etc.

For each content item a plurality of recommendation parameter values are accordingly generated and mapped to a multi-dimensional space with each axis corresponding to a recommendation parameter generated by a function reflecting the corresponding criterion. A multi-dimensional clustering is then performed and a number of clusters meeting a specific selection criterion or algorithm are selected. For example, clusters are selected which are far apart and which have high recommendation values for at least one of the recommendation parameters thereby resulting in a selection of clusters which are diverse and reflect different weightings or prioritisations of the different and potentially conflicting preferences.

A recommendation set of content items may then be generated by selecting content items from each selected cluster. For example, the recommendation set may be generated by selecting a predetermined number of content items from each cluster. The resulting recommendation set is then presented to the user allowing the user to select a content item.

This approach seeks to provide a user with a personalised content selection which is close to their personal preferences and interests whilst enabling other preferences and properties to also be considered. For example, input may provided from content providers and network operators and these inputs may be reflected in the generated recommendations. Furthermore, the multi-dimensional clustering approach allows such different parameters to be jointly considered while still allowing a recommendation set to be generated wherein e.g. one recommendation is predominantly reflecting the user preferences, another predominantly reflecting the content provider preferences, another predominantly reflecting a balance of user and content provider preferences etc.

A specific example of the recommendation approach will be described with reference to FIG. 1 and 2.

In the example, the content recommender is a computer arranged to receive radio programmes distributed over the Internet. Thus, the apparatus is coupled to the Internet and may receive a relatively large number of radio programmes from a remote server operated by a content provider. In the example, the provided radio service is not a real-time streaming radio service but rather is a download service wherein a large number of radio programmes are stored at the content server. The user of the content recommender can request one or more specific radio programmes which in response are downloaded to the content recommender from the content server. The content server may for example be operated by a conventional radio station that also provides access to previously transmitted radio programmes via the Internet. Thus, the content server may specifically provide a “podcasting” service.

It will be appreciated that the described principles are equally applicable to e.g. a real-time streaming service.

The content recommender comprises a network interface 101 which interfaces the content recommender to the Internet. In the example, the network interface 101 receives information from the content server which details a number of radio programmes that can be downloaded from the content server.

The content server may for example transmit radio programme information data at regular intervals. E.g. the information of the available content may be updated on a daily basis.

The radio programme information data can comprise a number of different attributes describing the radio programmes such as metadata describing a programme type (music, talk, news etc), a genre, a topic, associated artists, date/time that the material was recorded (if it is not live), a time the radio programme was broadcast (if applicable), whether the programme is part of a series etc. The provided download service may furthermore be a subscription based service wherein a user pays for each individual downloaded radio programme and the downloaded attributes can also include a cost for each individual radio programme.

It will be appreciated that in other embodiments, the radio programme information data may be obtained in other ways. For example, the data may simply be a programme guide stored on a third party server.

The content provider may also provide attributes that do not directly describe the radio programmes or contents thereof but which are aimed at biasing the recommendation system. For example, the received data may indicate a preference value set by the content provider. E.g. any radio programme that the content provider would encourage the users to download may be given a high value whereas a radio programme that the content provider is not particularly interested in encouraging users to download is given a low value.

Thus the method of generating recommendations initiates in step 201 wherein the network interface 101 receives a set of attributes for each radio program of the plurality of radio programmes that are available for download. The network interface 101 is coupled to a parameter processor 103 which is provided with the received attributes.

The parameter processor 103 executes step 203 wherein a recommendation value is generated for a number of recommendation parameters for each of the radio programmes that can be downloaded, i.e. for all available content items.

The parameter processor 103 comprises definitions of a number of recommendation parameters that are given as a function of attribute values for a subset of the received attributes. In the specific example, three different recommendation parameters are defined representing respectively user preferences, content provider preferences, and other considerations.

For each of the recommendation parameters a predetermined definition describes how a value of the recommendation parameter is determined for a radio programme from the attribute values of a specific subset of the attributes received for that radio programme. This definition is then applied to each radio programme such that a corresponding recommendation parameter value is determined for each radio programme. Thus, for each radio programme, the parameter processor 103 applies the definition to calculate a set of recommendation parameter values. In the specific example, three recommendation parameter values are calculated for each radio programme.

It will be appreciated that the definition of a recommendation parameter may e.g. be a function describing how the recommendation parameter value is calculated from the attribute values. However, the definition may also be given as a function or subroutine which is executed to generate a recommendation value. For example, the content recommender may be operable to generate a recommendation parameter value as an estimated user preference rating determined from comparing attributes comprised in metadata describing the radio programme to a user preference profile. The routine calculating this user preference rating may thus itself be considered a definition of a recommendation parameter, and the corresponding recommendation parameter value for a given radio programme is determined by executing this routine for the radio programme.

In the specific example, the recommendation parameters are orthogonal such that there is no correlation between the generated recommendation parameter values for a radio programme. This may specifically be achieved by the subsets of attributes used for the different recommendation parameters being different. Thus, in the specific example, each considered attribute is included in the definition of only one recommendation parameter.

In the specific example, a first parameter is determined to reflect an estimated user preference for the content item. Specifically, the parameter processor 103 is coupled to a user preference profile store 105 which stores a user preference profile for the user. It will be appreciated that a number of different methods of determining a user preference profile will be known to the person skilled in the art and for brevity no further description will be provided herein. In the example, the parameter processor 103 retrieves the user preference profile from the user preference profile store 105 and proceeds to determine a user preference recommendation parameter value for each of the radio programmes.

Specifically, a fitness value indicating how closely each radio programme fits to the user's preferences is calculated. This may e.g. be a distance measure looking at closeness of topics within an ontology (e.g. for a news item), or a confidence measure looking at relatedness of genre, or any other relevant mathematical distance measurement. For example, a number of received attributes are compared to corresponding attributes in the user preference profile. Dependent on the closeness and the user ratings, a distance measure can be calculated and assigned as the value of the user preference recommendation parameter. The attributes can specifically be characterising data for the radio programmes describing the content and/or context of the radio programme.

In the example, another recommendation parameter is related to a content provider consideration such as a content provider preference. This parameter may specifically be calculated from specific properties manually set by the content provider.

Specifically, the second recommendation parameter can be determined in response to a cost measure indicating a cost associated with downloading the radio programme. The cost measure may for example be a resource cost such as a computational resource or a communication resource required for downloading the radio programme.

As another example, the cost measure may indicate a monetary cost of downloading the radio programme, i.e. the second recommendation parameter may for example be a price for the content item set by the content provider. Thus, in such an example, the content provider can assign a price to each radio programme and this may directly be used as the second recommendation parameter value.

In the specific example, the cost measure is thus determined remotely and specifically in the content server. This may allow the content provider to have an impact on the generated recommendations and for example may result in the content recommender not only generating recommendations which are expected to have a high user rating but may e.g. also result in recommendations for high price content which is estimated to be of less interest to the user.

In the specific example, the first recommendation parameter is thus dependent on user preference data but does not depend on the cost measure whereas the second recommendation parameter is dependent on the cost measure but does not depend on user preference data. Accordingly a degree of decorrelation is provided between the different recommendation parameters. Specifically, the recommendation parameters are completely orthogonal if no other data is considered for these recommendation parameters (or more generally if no correlated data is used for both recommendation parameters).

In the example, a third recommendation parameter is calculated to reflect all other considerations that are not indicative of a user preference or an operator parameter (such as a cost measure set by the content provider). Such considerations may for example include a group user preference determined for a group of users, a popularity of the different radio programmes, a scarcity of the individual radio programmes, programme length etc. In the following description, the third recommendation parameter is considered to reflect added value parameters.

In some examples, the third recommendation parameter may reflect a cost measure associated with each radio programme. However, the cost measure used for the third recommendation parameter is determined by the content recommender itself and may specifically relate to a cost impact on the content recommender itself. For example, the cost measure may reflect a memory storage requirement for storing the individual radio programme etc.

It will be appreciated that in other embodiments other recommendation parameters may be used. It will also be appreciated that the use of three recommendation parameters is merely exemplary and that other numbers of recommendation parameters may be used in other embodiments.

The parameter processor 103 is coupled to a cluster processor 107 which is fed a set of recommendation parameter values for each radio programme available for download. In the example, each set comprises three recommendation parameter values thus corresponding to a specific location in a three-dimensional coordinate system with each axis corresponding to a recommendation parameter.

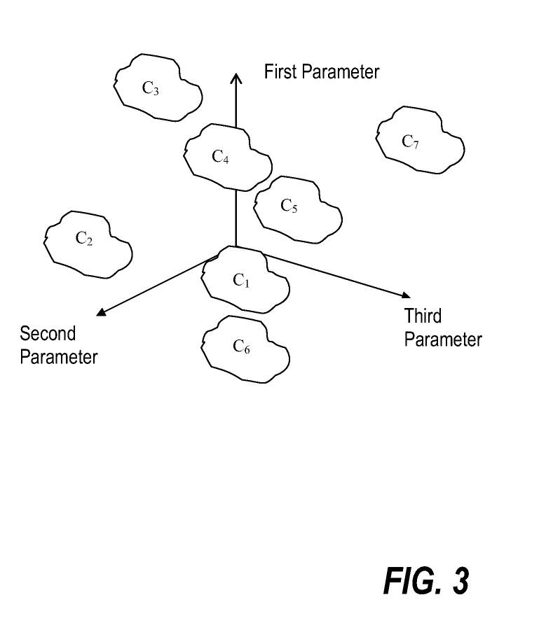

The cluster processor 107 is arranged to execute step 205 wherein a multi-dimensional clustering of the radio programmes is performed based on the recommendation values of the different sets. Thus, in a multi-dimensional coordinate system (a three-dimensional system in the specific example) where each dimension corresponds to one of the recommendation parameters, a clustering is performed to divide the radio programmes into a number of clusters. Thus, the cluster processor 107 generates a plurality of content clusters where each cluster comprises radio programmes close to each other in the multi-dimensional coordinate system. FIG. 3 illustrates a specific example of a clustering resulting from such an approach.

It will be appreciated that different clustering algorithms will be known to the person skilled in the art and that any suitable clustering algorithm may be applied without detracting from the invention.

A clustering algorithm generally attempts to minimize a criterion, such as an error measure, according to a distance function. It will be appreciated that the clustering may be performed using any suitable such distance function. In the specific example a simple Euclidian distance between sets of recommendation values in the three dimensional space is used.

The clustering algorithm may for example be a K-means clustering algorithm. A K-means clustering algorithm initially defines K clusters with given initial parameters (locations). The sets of recommendation parameters are then matched to the K clusters. The central location for each cluster is then recalculated based on the location of the sets that have been assigned to each cluster. The algorithm then proceeds to reallocate the sets to the K clusters in response to the updated central location. If these operations are iterated a sufficient number of times, the clustering converges resulting in K groups of sets of recommendation values which are close together.

The cluster processor 107 is coupled to a selection processor 109 which is arranged to execute step 207 wherein a set of content clusters is selected from the plurality of generated content clusters.

As a simple example, the selection processor 109 may be arranged to select a fixed number of clusters. The selection may for example be based on a multi-dimensional distance between the origin (intersection between the axis, i.e. corresponding to all parameter values being zero) and each cluster of the plurality of clusters. For example, for each cluster, a central position may be determined as an average value of the three recommendation parameters (corresponding to the three axes). The distance to origin may then be determined as a simple Euclidian distance (i.e. as the square-root of the sum of the square of each recommendation value). In an example wherein each recommendation parameter reflects an increasing preference for a content item by an increasing value of the recommendation parameter, an increasing Euclidian distance to origin may be considered to reflect an increased suitability of the content item for recommendation. Accordingly, the selection processor 109 can proceed to select the predetermined number of clusters that have the largest multi-dimensional distance to origin. For example, this approach may allow a maximisation of user satisfaction (fitness to user preference profile), profit (price) and added value.

Alternatively or additionally, the selection of clusters may be in response to a multi-dimensional distance between the clusters themselves. For example, the Euclidian distance between the central positions of each pair of clusters may be determined. The selection processor 109 may then generate all possible sets of clusters that contain the desired number of clusters and add the distances between all cluster pair combinations within each set. The resulting distance thus reflects the multi-dimensional distance between the clusters of the set. An increasing distance is likely to indicate an increasing diversity and specifically an increasing variation in the weight of the different recommendation parameters. Thus, the selection processor 109 may proceed to select the subset of clusters that has the highest accumulated distance value thereby providing a high degree of diversity for the selections. This approach may for example provide the user with a clear distinction of choice and avoid that the user has to spend time weighing up similar options

The selection processor 109 is coupled to a recommendation processor 111 which executes step 209 wherein at least one radio programme is selected from each content cluster of the selected set of clusters. For example, the recommendation processor 111 may simply select a predetermined number of radio programmes from each selected cluster. In the specific example, three clusters are selected and a single radio programme is selected from each.

Thus, the recommendation processor 111 generates a set of recommendations which comprise recommendations of the selected radio programmes. In the specific example, a set of three recommendations are generated. The content recommender comprises a user interface 113 which may execute step 211 wherein the recommendations are presented to the user who in turn may select one or more of the radio programmes resulting in these being downloaded to the content recommender.

Thus in the specific example, the content recommender selects one item from each of three clusters (this item may be the centroid or may be a random selection or selected in accordance with any suitable criterion) where the clusters are as far from the origin (zero price, zero relevance to the user, zero added value) and each other as possible. In the example of FIG. 3, one radio programme would thus be selected from each of clusters C₃, C₆ and C₇. As a result, the user is presented with a simple list of top 3 picks (i.e. three radio programmes which are considered to be highly appropriate for the user while at the same time representing very different trade-offs between different orthogonal considerations and preferences).

In some embodiments, the selection of the clusters may be by solving a constraint satisfaction problem. As will be well known to the skilled person, a constraint satisfaction problem is a mathematical problem where one must find states or objects that satisfy a number of constraints or criteria. Various methods for solving such constraint satisfaction problems will be known to the person skilled in the art and will accordingly not be described further herein.

Thus, in accordance with such embodiments, the selection processor 109 may first establish a set of constraints for the constraint satisfaction problem. Such constraints include constraints relating to the cluster locations and may specifically be static predetermined constraints.

For example, a constraint associated with a distance between the selected clusters may be defined. As a simple example, the constraint may require that a distance between any clusters in the selected cluster set is above a given value thereby ensuring that the resulting recommendations will be diverse and reflect different prioritisations of different recommendation parameters.

As another example, a constraint associated with a distance from origin to selected clusters may be defined. As a simple example, the constraint may require that a distance between origin and any clusters in the selected cluster is above a given value thereby ensuring that the resulting recommendations are likely to be particularly relevant given the different considerations.

As another example, a constraint of individual recommendation values for selected clusters may be defined. As a simple example, the constraint may require that all recommendation values for the first recommendation parameter are above a first value, all recommendation values for the second recommendation parameter are above a second value etc. This may ensure that all recommendations will at least have a minimum acceptable level for each recommendation parameter. For example, the constraint may guarantee that the estimated user preference for a recommendation is above a minimum level even if the recommendation is primarily generated due to the price or added value characteristics.

It will be appreciated that a number of other constraints may alternatively or additionally be generated and used to define the constraint satisfaction problem. Once the recommendation values are generated for all radio programmes the selection processor 109 may accordingly proceed to solve the constraint satisfaction problem to result in a selected set of clusters. This approach may result in an improved selection of clusters and/or may allow a large number of different requirements to be reflected in the generated recommendations.

In some embodiments, the selection processor 109 may further be arranged to relax the constraints if it is determined that solution to the constraint satisfaction problem does not meet a criterion. As a simple example, one or more constraints may be relaxed if the constraint satisfaction problem cannot be solved i.e. in the event of a failure to converge the constraint satisfaction problem. The constraints may for example be relaxed by removing one or more constraints completely or may e.g. relax the requirement imposed by a constraint. For example, the required minimum distance to origin may be reduced or discarded.

In some embodiments, the content recommender may further comprise a feedback processor 115 which is arranged to control the content recommender to modify the generated recommendations in response to user feedback. Thus, the content recommender can generate a second recommendation set e.g. by replacing one or more recommendations of the initially generated recommendation set by a new recommendation.

For example, if the user rejects the proposed recommendations, the content recommender can proceed to generate a new set of recommendations by selecting other radio programmes from the selected clusters. These recommendations may accordingly maintain the underlying characteristics even though different items are recommended.

However, if the user repeatedly rejects these recommendations, it is more likely that the selected clusters do not result in recommendations sufficiently appropriate for the user. Accordingly, the content recommender may proceed to select a different set of clusters and generate recommendations from these clusters. The second set of clusters is specifically selected using a different selection criterion. For example, a different set of constraints may be generated for the constraint satisfaction problem resulting in a different solution and thus different recommendations.

An example of such operation is further shown in FIG. 2 wherein step 211 of presenting the generated recommendations is followed by step 213 wherein a user feedback is obtained. Specifically, step 213 evaluates if a user input is received that includes a selection of one or more of the presented recommendations. If not, the feedback processor 115 may consider the presented recommendation set to be rejected. It will be appreciated that any criterion for determining that a user rejection has occurred may be used. For example, the user may directly provide an input corresponding to an explicit rejection.

If the recommendation set is not rejected, the method proceeds to step 215 wherein the recommendation process ends.

However, if the recommendation set is rejected, the method continues in step 217 wherein it is determined if the user has repeatedly rejected the generated recommendation sets. If not, the method returns to step 209 wherein a new recommendation set is generated by selecting at least one different content item from at least one content cluster of the generated set of content clusters. Thus, the content recommender proceeds to generate a new recommendation set using the same clusters as for the previous recommendation set.

However, if the user repeatedly rejects these recommendations, step 217 is followed by step 207 wherein a new set of content clusters is selected from the available content clusters. The new set of content clusters is selected using a different criterion than for the previous selection of clusters. For example, different constraints of the constraint satisfaction problems may be used. Thus, if the user repeatedly rejects the proposed recommendations arising from the currently selected clusters, the content recommender can proceed to select a different set of clusters and generate recommendations based on this new selection. Thus, the content recommender may adjust the generated recommendations in response to the user feedback.

It will be appreciated that any suitable criterion for determining that the user repeatedly rejects the recommendations may be used.

It will also be appreciated that the settings of the content recommender may be adapted in accordance with this feedback. For example, if the user does not reject recommendations after the cluster selection criterion has been changed, the new selection criterion may be used as the default selection criterion.

Thus, the system may incorporate a feedback loop that evaluates the user's action on receiving the recommendation set. If the user rejects the recommendations, the item selection step 209 may be repeated to generate new recommendations from the same clusters. If the user repeatedly rejects the recommendations, the algorithm may however proceed to adjust the selection criteria e.g. reducing the importance of maximising price or reducing the importance placed on added value considerations.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of content recommendation comprising:
providing a set of attributes for each content item of a plurality of content items;
determining a recommendation value for a first number of recommendation parameters for each of the plurality of content items, each recommendation parameter being defined as a function of attribute values for a subset of attributes of the set of attributes;
generating a plurality of content clusters by a multi-dimensional clustering of the plurality of content items in response to the recommendation values, each dimension corresponding to a recommendation parameter;
selecting a first set of content clusters from the plurality of content clusters; and
generating a first recommendation set of content items by selecting at least one content item from each content cluster of the first set of content clusters.

2. The method of claim 1 wherein the subsets of attributes for different recommendation parameters are disjoint.

3. The method of claim 1 wherein the recommendation parameters are orthogonal.

4. The method of claim 1 wherein at least one recommendation parameter is indicative of a user preference for the content item.

5. The method of claim 1 wherein a first subset of attributes for a first content item comprises characterising data for the first content item, and a recommendation value for the first content item is determined in response to the characterising data and a user preference profile for the user.

6. The method of claim 1 wherein at least one recommendation parameter is indicative of a cost measure associated with consuming the content item.

7. The method of claim 1 further comprising determining at least one recommendation value in response to a cost measure received from a remote source, the cost measure indicating a cost associated with consuming the content item.

8. The method of claim 7 wherein the remote source is a content provider server, and the method further comprises receiving at least one content item of the plurality of content items from the content provider server.

9. The method of claim 1 wherein at least one recommendation parameter is dependent on user preference data and not dependent on a cost measure associated with consuming the content item, and at least one other recommendation parameter is dependent on the cost measure and not dependent on the user preference data.

10. The method of claim 1 further comprising selecting the first set of content clusters in response to a multi-dimensional distance between origin and each cluster of the plurality of clusters.

11. The method of claim 10 wherein the first set of content clusters is selected as a predetermined number of clusters having a largest multi-dimensional distance to origin.

12. The method of claim 1 further comprising selecting the first set of content clusters in response to a multi-dimensional distance between clusters of the plurality of clusters.

13. The method of claim 12 wherein the first set of content clusters is selected as a predetermined number of clusters having a largest multi-dimensional distance between them.

14. The method of claim 1 wherein selecting the first set of content clusters comprises:
generating a constraint satisfaction problem having a set of constraints relating to cluster locations; and
selecting content clusters for the first set of content clusters by solving the constraint satisfaction problem.

15. The method of claim 14 wherein the set of constraints comprises constraints related to at least one of:
a. a distance between selected clusters;
b. a distance from origin to selected clusters; and
c. constraints of individual recommendation values for selected clusters.

16. The method of claim 14 further comprising relaxing the set of constraints in response to a determination that a solution to the constraint satisfaction problem does not meet a criterion.

17. The method of claim 1 further comprising generating a second recommendation set by selecting at least one different content item from at least one content cluster of the first set of content clusters in response to a user input.

18. The method of claim 1 further comprising generating in response to a user input a second recommendation set by selecting a second set of content clusters from the plurality of content clusters in response to a selection criterion which is different than a selection criterion used to select the first set of content clusters.

19. The method of claim 1 wherein selecting the set of content clusters comprises selecting a predetermined number of content clusters for the set of content clusters.

20. A content item recommendation apparatus comprising:
a unit for receiving a set of attributes for each content item of a plurality of content items;
a unit for determining a recommendation value for a first number of recommendation parameters for each of the plurality of content items, each recommendation parameter being defined as a function of attribute values for a subset of attributes of the set of attributes;
a unit for generating a plurality of content clusters by a multi-dimensional clustering of the plurality of content items in response to the recommendation values, each dimension corresponding to a recommendation parameter;
a unit for selecting a first set of content clusters from the plurality of content clusters; and
a unit for generating a first recommendation set of content items by selecting at least one content item from each content cluster of the first set of content clusters.
